(19) United States
(12) Patent Application Publication
(10) Pub. No.: US 2002/0101122 A1
(43) Pub. Date: Aug. 1, 2002

(54) Electromechanically controlled changeover switch

(75) Inventors: Lance P. Haines, Wilmington, MA (US); Beat J. Arnet, Cambridge, MA (US)

Correspondence Address: Edmund Paul Pfleger, HAYES, SOLOWAY, HENNESSEY, GROSSMAN & HAGE, P.C., 130 W. Cushing Street, Tucson, AZ, 85701, US

(73) Assignee: Solectria Corporation

(21) Appl. No.: 09/772,820

(22) Filed: Jan. 30, 2001

(51) Int. Cl. H02K 19/12; H02P 7/00; H02P 5/00

(52) U.S. Cl. 310/68 E; 310/68 R; 318/495

(57) ABSTRACT

A controllable switching mechanism integrally housed within a motor to optimally couple the windings of an AC motor for improved torque-speed characteristics. The switching mechanism includes a plurality of double throw switches each with a first and second closed position. The first closed position results in connecting the windings of the AC motor in one configuration for improved torque at lower rotor speeds. The second closed position results in connecting the windings of the AC motor in another configuration for improved torque at higher speeds. The winding configurations may be wye for lower speeds and delta for higher speeds. An accompanying controller, based on various inputs, optimally senses the best time for switching between configurations and sends appropriate control signals to the switching mechanism housed with the AC motor.

### FIELD OF THE INVENTION

The present invention relates to electric motors, and, more particularly for optimally coupling the windings of a motor.

### BACKGROUND OF THE INVENTION

AC motors are widely used for a variety of applications. Such applications can include industrial or automotive uses. In most uses, the AC motor is needed to drive a mass up to a certain speed and maintain that speed at a steady state. Because of this, the AC motor has higher torque requirements at low speeds for acceleration and lower torque requirements at higher speeds once steady state is reached.

Increasing the number of turns of the motor winding could increase torque at lower speeds by allowing better use of the current from a power supply. However, this would increase the voltage of the power supply needed to maintain the power at higher speeds. This would cause the power supply to be over-sized resulting in increased cost and diminished efficiency. Consequently, an improved AC motor would have more turns at lower speeds and less turns at higher speeds.

One way to accomplish this is to switch the primary windings of an AC motor from wye connection at low speeds to a delta connection at high speeds. This is because the number of turns of a delta connection is a factor of 3 [NsY=NsΔ(1/3): where NsY is the number of turns in a Y connection and NsΔ is the number of turns in a delta connection less than the number of windings of a wye connection. Another way to accomplish this is to switch the primary winding of an AC motor from parallel wye to series wye. In this configuration, the number of windings is a factor of two less in the series wye connection than in the parallel wye connection. Additional configurations that would reduce the number of turns could also be deduced by those skilled in the art. Ideally, the connection is switched to maximize torque output depending on which configuration would be more advantageous at a given speed. This would allow for a high starting torque without compromising torque at higher speeds.

The prior art achieves such switching by employing a switch external to the motor. This switch is typically a heavy-duty contactor or switchgear. In addition, multiple (at least six) heavy gauge conductors must run from the switchgear to the motor and an additional three heave gauge conductors must run from the switchgear to a motor controller. This configuration would also require a control module to intelligently switch the motor's configuration and inform the motor controller of the change. Typically motor controllers to control and utilize such external switchgear are difficult, if not impossible, to find commercially available. Without proper control, the system would likely be unstable and efficiency benefits would be missed.

Accordingly, there is a need in the art for a reliable and efficient controllable switch integrally housed within a motor to switch between windings in an AC motor without using external switchgear.

### SUMMARY OF THE INVENTION

The present invention solves the aforementioned problems in the prior art by providing an integrated motor with a winding changeover switch. The switch includes a contact bar having a first plurality of contact points connected in common and a second plurality of contact points electrically isolated from the first plurality of contact points. The integrated motor further includes a plurality of stator winding comprising a first plurality of stator winding terminals each connected to a movable contact member and adapted to make electrical contact with the first plurality of contact points or the second plurality of contact points, respectively; a second plurality of stator winding terminals each connected to the second plurality of contact points; and a controllable movable bar having the movable contact members affixed thereto. The moveable bar is controlled to move the contact members with respect to the contact bar to electrically connect or isolate the first plurality of stator winding terminals and the second plurality of stator winding terminals.

In another aspect of the present invention, an integrated three phase motor and motor winding changeover switch is provided. The integrated three phase motor includes a motor housing comprising a three phase motor including three stator windings each comprising winding terminals on each side of the windings. Further, a controllable switch is provided to couple or isolate the winding terminals to form a delta configuration or a wye configuration. Integration is ensured by forming the stator windings and the switch within the motor housing. To control the switch a controller is provided to generate a control signal for controlling the switch to couple or isolate the winding terminals.

In all the embodiments of the present invention, the controllable moveable bar includes an elongated bar member formed of a ferromagnetic material having the contact members affixed thereto, a biasing device causing the elongated bar to move in a predetermined direction, and a controllable solenoid magnetically coupled to the elongated bar member to move the bar member in a direction opposite to said biasing device. The biasing device can comprise a spring, a bistable spring, or a second solenoid magnetically coupled to the bar member. Each of these specific biasing devices cause the bar to move in a direction opposite the solenoid.

It will be appreciated by those skilled in the art that although the following Detailed Description will proceed with reference being made to preferred embodiments and methods of use, the present invention is not intended to be limited to these preferred embodiments and methods of use. Rather, the present invention is intended to be limited only as set forth in the accompanying claims.

Other features and advantages of the present invention will become apparent as the following Detailed Description proceeds, and upon reference to the Drawings, wherein like numerals depict like parts, and wherein:

### BRIEF DESCRIPTION OF THE DRAWINGS

FIG. 1 depicts a sample torque-speed plot or envelope for delta and wye winding configurations of conventional AC motors;

FIG. 2 depicts a block diagram of an exemplary switching system consistent with the present invention;

FIGS. 3A and 3B depict wye and delta winding configurations, respectively, including three motor windings with their terminals that can be connected in various ways;

FIG. 4 depicts the details of the integrated motor shown in FIG. 1 including a switching mechanism for use in an exemplary wye-delta switching configuration;

FIG. 5 depicts a schematic diagram of an exemplary type of double pole switch used in the switching mechanism of the present invention;

FIG. 6A and FIG. 6B depict cross sectional views of a first and second exemplary switch type for use is the switching mechanism of the present invention;

FIG. 7 depicts a cross sectional view of a third exemplary switch type employing a bistable lever-spring; and

FIG. 8 depicts a detailed view of an AC motor modified with a switching mechanism consistent with the present invention.

### DETAILED DESCRIPTION OF THE INVENTION

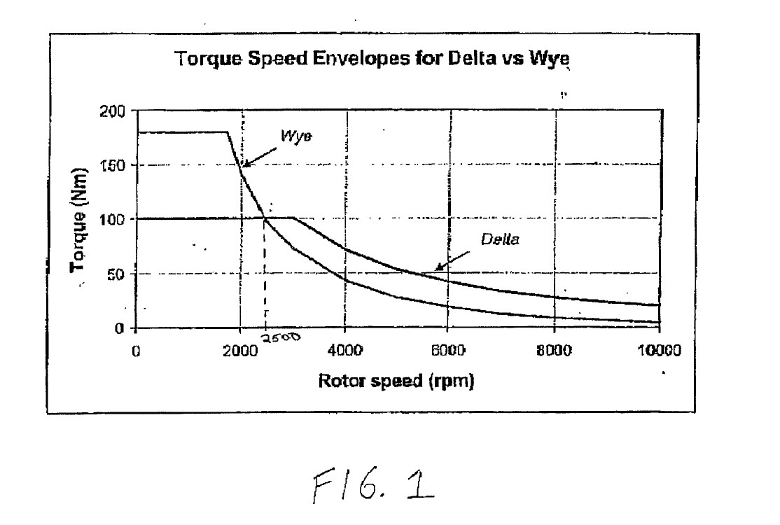

With reference to FIG. 1, a sample torque-speed plot for delta and wye winding configurations of conventional AC motors is shown. As shown, the wye winding results in the greatest torque for rotor speeds less than approximately 2,500 rpm. The delta winding results in greater torque for rotor speeds greater than approximately 2,500 rpm. This is because the number of turns in the delta configuration is less than in the wye configuration as explained in the Background of the Invention. Ideally, the connection is switched from wye to delta at 2500 rpm as the rotor speeds up in the example of FIG. 1. It is also switched from delta back to wye at 2500 rpm as the rotor slows down. This allows for a high starting torque without compromising torque at higher speeds.

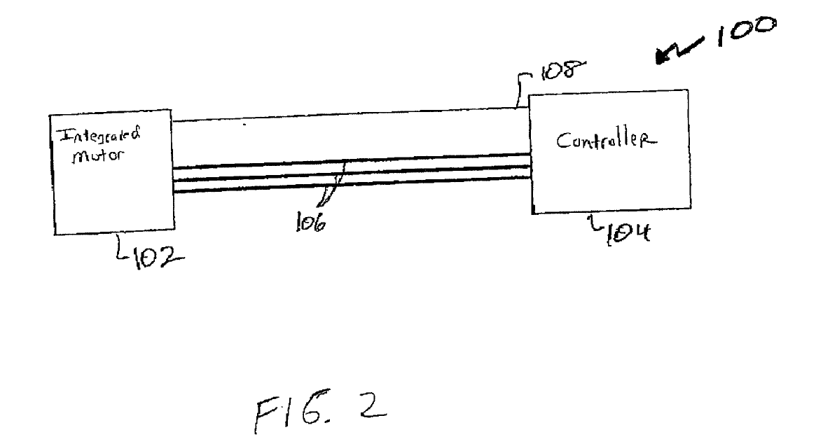

An exemplary switching system of the present invention to accomplish such switching is shown in FIG. 2. The switching system 100 comprises an integrated motor 102 and controller 104. The integrated motor includes a switching mechanism to switch between various winding configurations such as delta and wye, as directed by signals from the controller 104. Three phase power cables 106 are connected to the controller and the integrated motor, and a signal line 108 is used to communicate information there between. Although not shown in the drawings, the controller preferably includes current and positional feedback data from the motor so the switch commands are generated in accordance to optimal operating conditions, such as the speed-torque envelopes depicted in FIG. 1. To that end, the motor of the present invention can be modified with position/speed sensors (e.g., conventional electrical, electro-optical, and/or mechanical rotational position sensors as are known in the art). Measurement of current information may also be relevant, and may be measured on the supply line to the controller, and the appropriate circuitry to derive current data from the motor (e.g., sensor feedback resistor in series with motor, or Hall sensor). Of course, multiple speed torque envelopes may be chosen in accordance with various motor and operating parameters. To that end, controller 104 preferably includes the appropriate circuitry/logic to generate a switch signal (via signal line 108) based on speed and torque information from the motor 102, and may comprise state machine type logic and/or a microprocessor programmed to generate such a switch command, and may further be constructed out of custom and/or conventional circuitry to accomplish the same.

Advantageously, a switching mechanism is part of the integrated motor's 102 housing so it is “transparent” to the user and the switching system does not require any external switchgear. In addition, only three traditional power cables 106 (plus signal line 108) are needed to connect the motor to the controller 104 as opposed to the multiple cables (minimum of nine) utilized in prior art configurations.

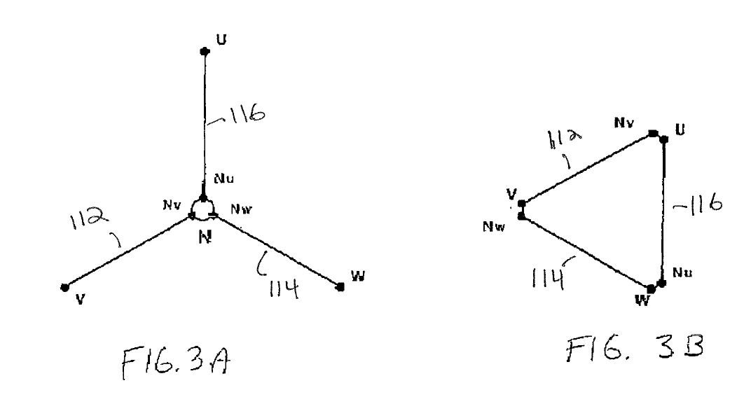

Turning to FIGS. 3A and 3B there is shown six points U, V, W, Nu, Nv, Nw that can be connected to develop wye (FIG. 3A) and delta (FIG. 3B) configurations. These six points represent the terminals or leads of each of the stator windings 112, 114 and 116 in a typical three-phase system. The wye configuration of FIG. 3A shows the three windings so that one terminal of each winding Nu, Nv, Nw is connected to a neutral point N. FIG. 3B shows a delta connection for the same three windings in which each terminal is connected in series, as shown. The three windings and terminals form a triangle in the circuit diagram representation of FIG. 3B. Starting with terminal U and working counterclockwise in FIG. 3B, the six points U-Nv-V-Nw-W-Nu are connected successively in series.

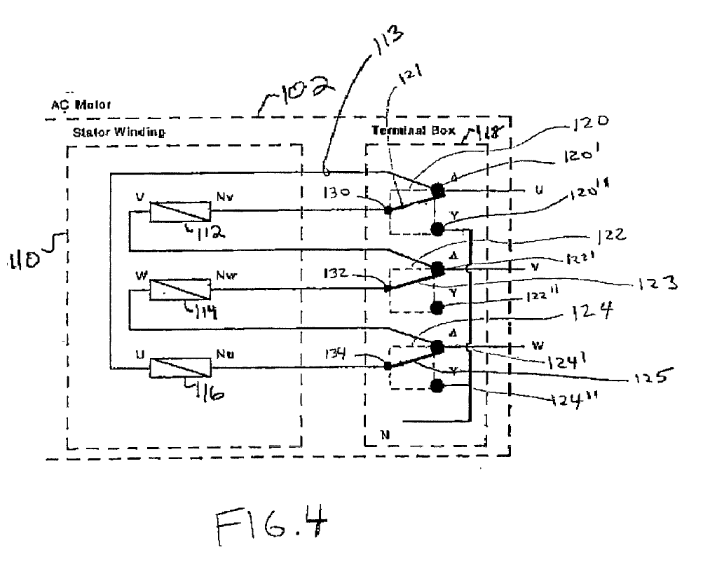

Turning to FIG. 4, there is shown an exemplary switching mechanism 118 employing three double-throw switches 120, 122, and 124 to switch between the six points U, V, W, Nu, Nv, Nw shown in FIGS. 3A and 3B to effectively obtain a delta or wye configuration. The switching mechanism 118 is housed in a terminal box. The stator windings and terminals 110 are preferably close to the terminal box to allow connection via conductors 113 there between. The stator windings and terminals 110 comprise three separate windings 112, 114, and 116 and terminals U, V, W, Nu, Nv, Nw corresponding to each of the three phases. Points V, W and U represent one side (terminal) of the windings 112, 114 and 116, respectively, and points Nv, Nw and Nu represent the other side. Both the stator windings and terminals 110 and the switching mechanism 118 are located within an AC motor housing 102 negating the need for any external switchgear.

The double throw switches 120, 122, and 124 have two closed positions. With reference numerals to the first switch 120, each switch comprises a stressed blade contact member 121, a common terminal 130, a first contact terminal 120′, and a second contact terminal 122″. When the stressed contact blade members 121, 123, and 125 for each of the three switches 120, 122, and 124 are in their first closed position, a delta connection configuration results. This occurs when each stressed contact blade member 121, 123, and 125 completes the circuit from their respective common terminal 130, 132, and 134 to their respective first contact terminals 120′, 122′, and 124′. When all the stressed contact members 121, 123, and 125 for each of the three switches 120, 122, and 124 are in their second closed position, a wye connection configuration results. This occurs when each stressed contact blade member 121, 123, 125 completes the circuit from their respective common terminals 130, 132, and 134 to their respective second contact terminals 120″, 122″, and 124″.

For example, recall that in the delta connection of FIG. 3B the six points starting with U and working counterclockwise in series were U-Nv-V-Nw-W-Nu. FIG. 4 illustrates that with the double-pole switches in their respective first closed positions connecting their respective common terminals 130, 132, and 134 to their respective first contact terminals 120′, 122′, and 124′, the same six points are connected in series in the same fashion. Alternatively, with the double pole switches in their second closed position, a wye connection is established where each terminal of each winding Nu, Nv, Nw is connected to a neutral point N. It will be apparent to those skilled in the art that a similar wiring diagram as detailed in FIG. 4 could be established to switch between a parallel and series wye configuration and other configurations to achieve similar results.

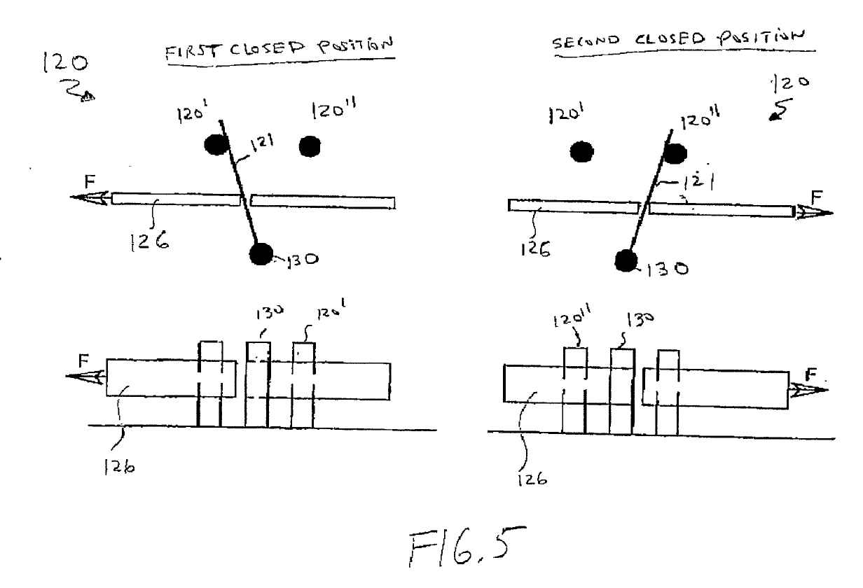

As described in reference to FIG. 4, the switching mechanism is made up of a plurality of double throw switches 120, 122, and 124. A schematic diagram sample one such switch 120 is shown in FIG. 5 in two separate ways. The upper schematic diagram shows the switch in its first and second closed positions respectively. The common terminal 130 of the switch 120 has a contact member 121 (and 123 and 125, not shown) affixed thereto. The contact member is forced into its first and second closed positions by actuation bar 126 actuated by a force F. The contact members are affixed to the bar 126 and rotate about the terminal (e.g., terminal 130 as shown). When the force F acts in the negative x-axis direction, the switch arm 121 is forced to connect with terminal 120′ forming its first closed position. When the force F acts in the positive x-axis direction, the switch arm 121 is forced to connect with terminal 120″ forming its second closed position.

Another schematic method of representing the switch is shown in the lower portion of FIG. 5. In this schematic, the actuation bar makes contact between terminals 130 and 120′ in the first closed position. In the second closed position, the actuation bar makes contact between terminals 130 and 120″.

The force F actuating the bar 126 is controllable by an external signal generated by the controller 104 and communicated to the switching mechanism 118 via signal line 108. In operation therefore, at least one coil and possibly a spring must be included in the switch. Note that contact member 123 and 125 can be similarly controlled.

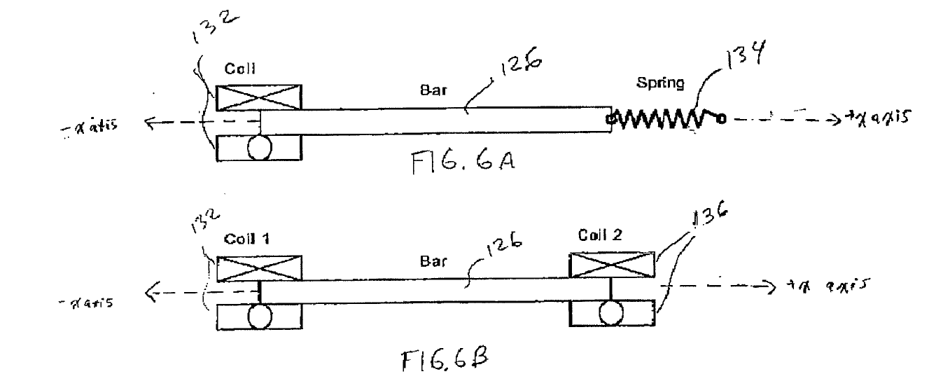

FIG. 6A and FIG. 6B depict a first and second exemplary switch type for use as a switching mechanism in the present invention. FIG. 6A depicts a solenoid 132 comprising a coil wrapped around an armature on one end of the actuation bar 126 and a bias spring 134 on the opposite end of the bar 126. In an exemplary embodiment the armature is made of ferromagnetic material such as iron, steel, cobalt, or nickel, and the bar 126 is made of magnetic material. In operation, current is fed into the coil conductors which induces a magnetic field and thereby pulls the bar 126 in the negative x-axis direction shown in FIG. 6A. The coil is energized to guarantee a good contact for the switch. On the opposite end of the bar, a spring is attached to bias the bar back in the positive x-axis direction when the coil is no longer energized. As such, the bar moves back and forth to engage the first and second closed positions of the switch. FIG. 6B is similar in operation to that described in reference to FIG. 6A except that two solenoids 132 and 136 are used on each side of the bar 126. No biasing spring is used in this configuration.

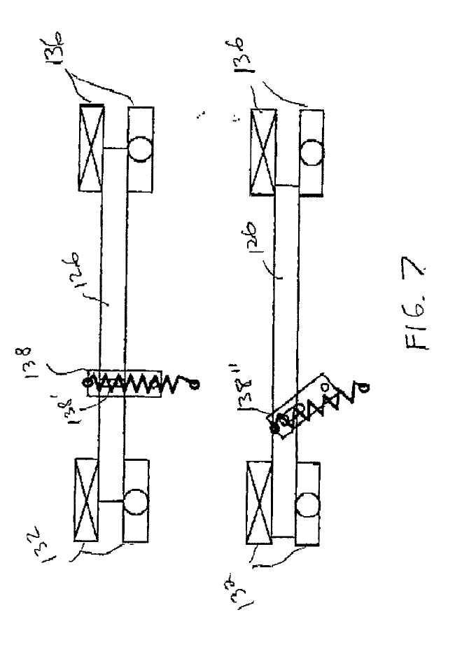

FIG. 7 shows a third embodiment for a switch to be utilized in the present invention. This embodiment uses two solenoids 134 and 136 on either side of the actuation bar 126 and a bistable lever-spring 138. This bistable lever-spring 138 has two stable states 138′ and 138″ that permits two stable outputs for the first and second closed position of the switching mechanism 118. As opposed to the switch embodiment described with reference to FIG. 6A and FIG. 6B which requires current to constantly flow to permanently magnetize the bar 126, this embodiment enables only a short current pulse to be applied to the coils in either solenoid 134 and 136. This short current pulse allows the bistable lever-spring 138 to move to position 138′ or to position 138″. This thereby latches the bar 126 in its first closed or second closed position, and the bar can be maintained in either position without the need to keep the coils continuously energized.

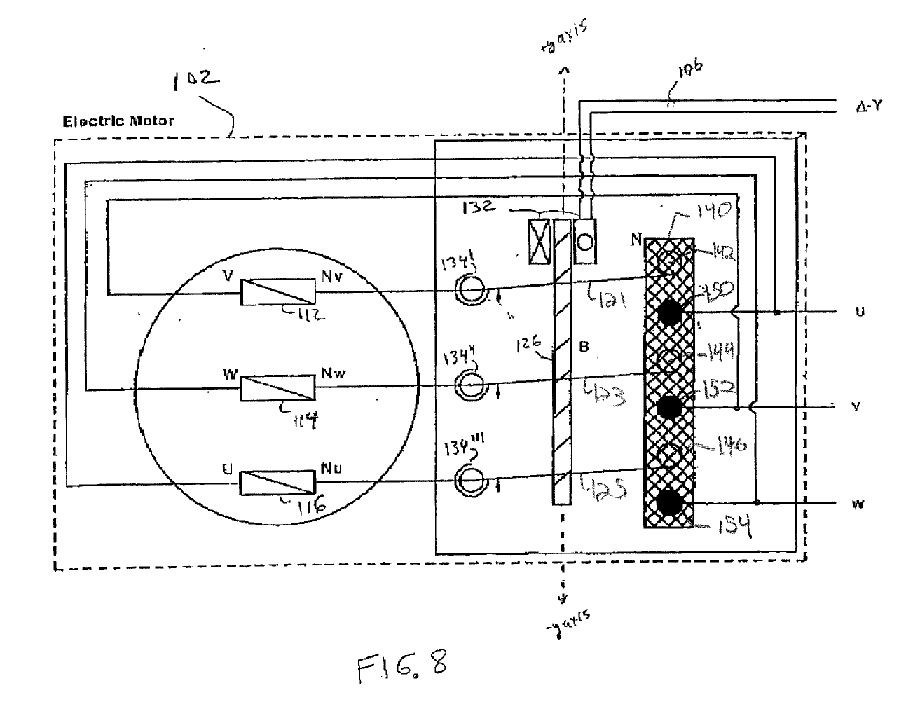

Turning to FIG. 8, the operation of the controllable switch is described with reference to one exemplary embodiment. This exemplary embodiment switches between a wye and delta configuration and utilizes a similar actuation bar as shown in FIG. 6A. At slower rotor speeds, the torque output is greater if the AC motor's winding are in a wye configuration. The controller 104 described earlier with reference to FIG. 2 decides, based on a number of factors and corresponding torque speed envelope curves, when is the proper time to switch between a wye and delta configuration. When this occurs a signal is sent to the switching mechanism 118 via signal wires 108. Current is supplied to the solenoid 132 via two of the three power cables 106. The switch mechanism includes the actuation bar 126 and a contact bar 140. Contact bar 140 is provided as a partial bus bar, and connects the motor in a delta or wye configuration, as follows. Contact bar 140 includes a plurality of first contact positions 142, 144 and 146 connected to the Nv, Nw and Nu terminals, respectively as shown. More particularly, terminals Nv, Nw and Nu are connected to the respective contact points on the contact bar via contact members 121, 123 and 125, respectively. Contact bar 140 and contact points 142, 144 and 146 comprise electrically common material, and thus define the common (neutral) point N. Thus, in the position shown in FIG. 8, Nv, Nw and Nu are connected in common at N thereby forming a wye connection. Contact bar 140 further comprises a second plurality of contact points 150, 152 and 154 each connected to the U, V and W winding positions, respectively as shown. Contact points 150, 152 and 154 are electrically isolated from the contact bar 140 in the wye position as depicted, but permit electrical contact between contact positions 142, 144, 146 and 150, 152 and 154 to form a delta winding.

When current is supplied to energize the coils of the solenoid 132, a resultant magnetic field is induced which pulls the actuation bar 126 in the positive y-axis direction as shown in FIG. 8. This effectively shorts the three terminals Nv, Nw, and Nu to a common neutral point N creating a wye configuration. As long as the coils stay energized, the bar remains in this position and the AC motor remains in a wye configuration. At the optimal time as determined by the controller 104, a signal is given to switch to a delta configuration. Current no longer flows in the coils thereby demagnetizing the solenoid and allowing the springs 134′, 134″, and 134′″ to pull the actuation bar 126 back to its second closed position. This causes contact members 121, 123 and 125 to move and make electrical contact with points 150, 152 and 154 of the contact bar. In this second closed position a delta connection is achieved as all the points U-Nv-V-Nw-W-Nu are now connected in series. As such, a reliable and efficient controllable switch integrally housed within a motor to switch between windings in an AC motor is achieved.

Contact bar 140 can be formed with multiple conduction layers to achieve the aforementioned contact positions to form delta or wye winding configurations. For example, contact bar 140 can comprise a first conductive layer that forms the common contact points 142, 144 and 146, and a second conductive layer to form the second isolated contact points 150, 152 and 154. Of course, the second contact points may be comprised of individually conductive posts formed in the switch bar. Contact member 121, 123 and 125 my comprise connective ends to make contact with the common points 142, 144 and 146 and the isolated points 150, 152 and 154.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention.

What is claimed is:

1. An integrated motor winding changeover switch for a multiphase motor, comprising:
a contact bar having a first plurality of contact points connected in common and a second plurality of contact points electrically isolated from said first plurality of contact points;
a plurality of stator winding comprising a first plurality of stator winding terminals each connected to a movable contact member and adapted to make electrical contact with said first plurality of contact points or said second plurality of contact points, respectively;
a second plurality of stator winding terminals each connected to said second plurality of contact points; and
a controllable movable bar having said movable contact members affixed thereto, said moveable bar being controlled to move said contact members with respect to said contact bar to electrically connect or isolate said first plurality of stator winding terminals and said second plurality of stator winding terminals.

2. A switch as claimed in claim 1, wherein said controllable movable bar having a first position connecting said first plurality of stator winding terminals to said first plurality of contacts via said contact members, and a second position connecting said first plurality of stator winding terminals to said second plurality of contacts via said contact members.

3. A switch as claimed in claim 2, wherein said first position causing said first plurality of stator winding terminals to be connected in common and electrically isolated from said second plurality of stator winding terminals, and said second position causing said first and second plurality of stator winding terminals to be connected in series.

4. A switch as claimed in claim 3, wherein said plurality of stator windings comprise three stator windings forming a three phase motor, and said first position forming said stator windings into a wye configuration, and said second position forming said stator windings into a delta configuration.

5. A switch as claimed in claim 1, wherein controllable movable bar comprising an elongated bar member formed of a ferromagnetic material having said contact members affixed thereto, a biasing device causing said elongated bar to move in a predetermined direction, and a controllable solenoid magnetically coupled to said elongated bar member to move said bar member in a direction opposite to said biasing device.

6. A switch as claimed in claim 5, wherein said biasing device is a spring.

7. A switch as claimed in claim 5, wherein said biasing device is a bistable spring.

8. A switch as claimed in claim 5, wherein said biasing device is a second solenoid magnetically coupled to said bar member.

9. A switch as claimed in claim 1, wherein said plurality of stator winding comprise three stator winding forming a three phase motor, said controllable movable bar being controlled to electrically couple said first and second plurality of stator winding terminals to form a delta configuration of said stator windings, and further being controlled to electrically couple said first plurality of terminals together and electrically isolate said first plurality of terminals from said second plurality of terminals.

10. A switch as claimed in claim 9, wherein said movable bar being controlled by control signals indicative of torque information related to a motor formed by said plurality of stator windings.

11. A switch as claimed in claim 9, wherein said movable bar being controlled by control signals indicative of speed information of a motor formed by said plurality of stator windings.

12. An integrated three phase motor and motor winding changeover switch, comprising:
a motor housing comprising a three phase motor including three stator windings each comprising winding terminals on each side of said windings, and a controllable switch to couple or isolate said winding terminals to form a delta configuration or a wye configuration, said stator windings and said switch formed within said motor housing; and
a controller generating a control signal for controlling said switch to couple or isolate said winding terminals.

13. An integrated motor as claimed in claim 12, further comprising three power cables and a control line cable coupled between said controller and said motor housing for controllably delivering three phase power and said control signal to said motor.

14. An integrated motor as claimed in claim 12, said switch comprising a controllable movable bar having said movable contact members affixed thereto, said moveable bar being controlled to move said contact members with respect to said contact bar to electrically connect or isolate said winding terminals to connect said windings in a delta or wye configuration.

15. An integrated motor as claimed in claim 14, wherein said controllable movable bar comprising an elongated bar member formed of a ferromagnetic material having said contact members affixed thereto, a biasing device causing said elongated bar to move in a predetermined direction, and a controllable solenoid magnetically coupled to said elongated bar member to move said bar member in a direction opposite to said biasing device.

16. An integrated motor as claimed in claim 15, wherein said biasing device is a spring.

17. An integrated motor as claimed in claim 15, wherein said biasing device is a bistable spring.

18. An integrated motor as claimed in claim 15, wherein said biasing device is a second solenoid magnetically coupled to said bar member.

19. An integrated motor as claimed in claim 15, wherein said movable bar being controlled by control signals indicative of torque information related to a motor formed by said plurality of stator windings.

20. An integrated motor as claimed in claim 15, wherein said movable bar being controlled by control signals indicative of speed information of a motor formed by said plurality of stator windings.
